(19) United States
(12) Patent Application Publication
(10) Pub. No.: US 2025/0272629 A1
(43) Pub. Date: Aug. 28, 2025

(54) INFORMATION PROCESSING APPARATUS AND INFORMATION PROCESSING METHOD

(71) Applicant: CANON KABUSHIKI KAISHA, Tokyo (JP)

(72) Inventors: SHOKO MIURA, Tokyo (JP); MASAKAZU FUJIKI, Kanagawa (JP); TAKATOSHI SATO, Kanagawa (JP)

(21) Appl. No.: 19/050,345

(22) Filed: Feb. 11, 2025

(30) Foreign Application Priority Data
Feb. 28, 2024 (JP) 2024-028162

(51) Int. Cl. G06Q 10/0631; B25J 11/00

(52) U.S. Cl. CPC G06Q 10/063112; B25J 11/008

(57) ABSTRACT

An information processing apparatus includes a workability information acquisition unit configured to acquire workability information related to a space in which a robot work service provider can provide work in association with the robot work service provider, a first spatial information generation unit configured to generate first spatial information related to a space based on the workability information acquired by the workability information acquisition unit, a work request information acquisition unit configured to acquire work request information related to a space in which a robot work service client desires to request work in association with the robot work service client, a second spatial information generation unit configured to generate second spatial information related to a space based on the work request information acquired by the work request information acquisition unit, and a degree of coincidence determination unit configured to determine a degree of coincidence based on the first spatial information and the second spatial information.

### BACKGROUND OF THE INVENTION

### Field of the Invention

The present invention relates to an information processing apparatus and an information processing method for providing work by a robot.

### Description of the Related Art

In recent years, robots have been increasingly utilized in various fields. Although there is a desire to introduce robots, robot sharing services have appeared due to cost concerns. Japanese Patent Application Laid-Open No. 2020-046791 proposes a system that collects and stores work histories of robots and reserves a robot most appropriate for the desired work content.

However, in the method disclosed in Japanese Patent Application Laid-Open No. 2020-046791, in a case in which there is a plurality of service providers offering work by a robot as a service, service clients are unable to select a provider that meets the work requirements.

### SUMMARY OF THE INVENTION

An information processing apparatus comprising at least one processor and a memory holding a program that makes the processor function as: a workability information acquisition unit configured to acquire workability information related to a space in which a robot work service provider can provide work in association with the robot work service provider; a first spatial information generation unit configured to generate first spatial information related to a space based on the workability information acquired by the workability information acquisition unit; a work request information acquisition unit configured to acquire work request information related to a space in which a robot work service client desires to request work in association with the robot work service client; a second spatial information generation unit configured to generate second spatial information related to a space based on the work request information acquired by the work request information acquisition unit; and a degree of coincidence determination unit configured to determine a degree of coincidence based on the first spatial information and the second spatial information.

Further features of the present invention will become apparent from the following description of embodiments with reference to the attached drawings.

### BRIEF DESCRIPTION OF THE DRAWINGS

FIG. 1 is an explanatory diagram illustrating the use of an information processing apparatus in the present invention.

FIG. 2 is a functional block diagram illustrating an example of the information processing apparatus according to the first embodiment.

FIG. 3 is a block diagram illustrating an example of a hardware configuration of the information processing apparatus according to the first embodiment.

FIG. 4A and FIG. 4B are flowcharts illustrating examples of the operation of the information processing apparatus according to the first embodiment.

FIG. 5 is a flowchart explaining an example of the operation of a first spatial information generation unit in the information processing apparatus according to the first embodiment.

FIG. 6 is a functional block diagram illustrating an example of the information processing apparatus according to the fifth embodiment.

FIG. 7A and FIG. 7B are diagrams illustrating examples of a display device of the information processing apparatus according to the fifth embodiment.

FIG. 8 is a flowchart explaining an example of the operation of the information processing apparatus according to the first variant embodiment.

### DESCRIPTION OF THE EMBODIMENTS

In the first embodiment, an information processing apparatus will be explained in which a robot work service client is set as a user, and the degree of coincidence between a request of the client and a work history of a service provider is determined so that a robot work service provider that meets a work requirement of the user can be selected. In the first embodiment, the work requirement of the user is that the space in which the provider can provide the robot work and the space in which the client desires to request robot work are similar. In order to determine the degree of coincidence, the information processing apparatus in the first embodiment acquires spatial information from the service client and the service provider. In this context, the spatial information refers to information on a location where the robot actually performs work, including identifying the types of objects in the workspace and the respective locations of the objects. The degree of coincidence indicates the result of determining the similarity between the workspace in which a robot service provider can provide work and the workspace that the robot service client desires to request work, based on the spatial information. In the first embodiment, it is assumed that as the similarity in terms of objects and the placement locations of the objects in the spaces are higher, the degree of coincidence is higher. Note that the configuration as illustrated in the first embodiment is merely an example, and the present invention is not limited to the illustrated configuration.

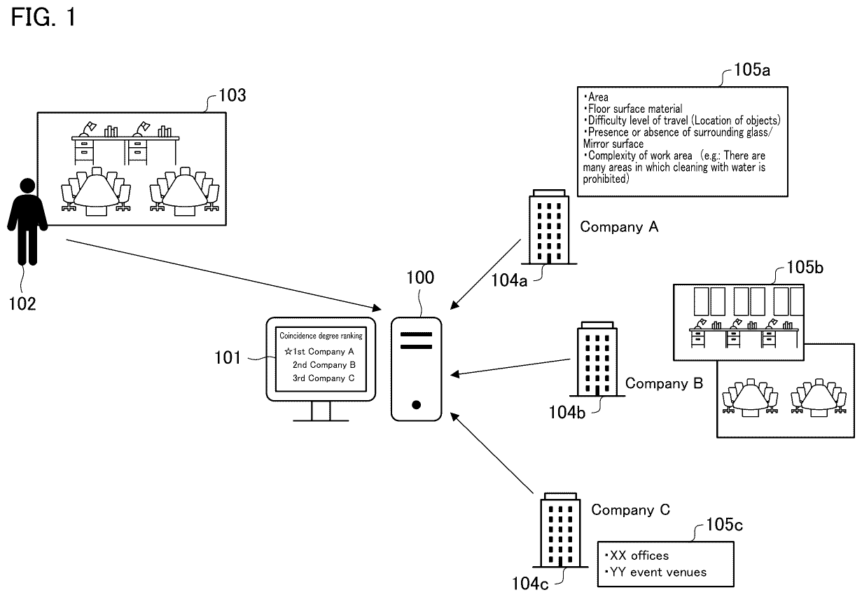

FIG. 1 is a diagram showing the use of an information processing apparatus in the present invention. A PC 100 is used to implement the information processing apparatus in the first embodiment. Reference numeral 101 denotes a display device. A robot work service client 102 who is a user inputs, as work request information 103, a work image group of a space for which work is desired to be requested, which is work request information, to the information processing apparatus. Each of the robot work service providers 104a to 104c inputs workability information 105a to 105c to the PC 100 as information indicating workability conditions. The PC 100 determines the degree of coincidence and displays the result on the display device 101.

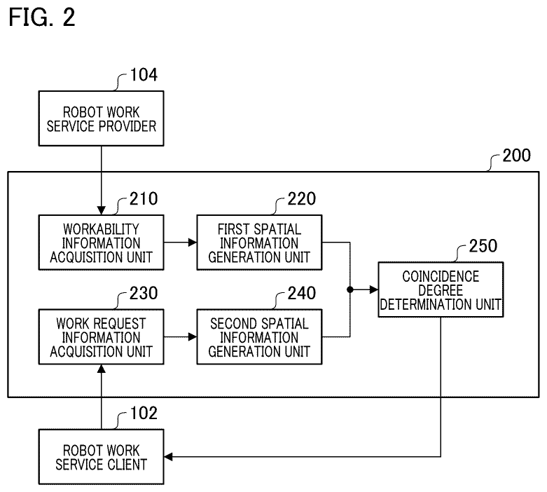

FIG. 2 shows a functional block diagram illustrating the information processing apparatus in the present invention. It should be noted that the functional blocks shown in FIG. 2 may be housed in different housings and may be configured by separate devices wherein the separate devices are connected to each other via signal paths.

An information processing apparatus 200 according to the first embodiment is configured by a workability information acquisition unit 210, a first spatial information generation unit 220, a work request information acquisition unit 230, a second spatial information generation unit 240, and a degree of coincidence determination unit 250. The workability information acquisition unit 210 acquires from the robot work service provider 104, as workability information, a group of captured images of a space in which the robot work service provider 104 can provide work. The workability information acquisition unit 210 acquires this workability information in association with the robot work service provider 104. The work request information acquisition unit 230 acquires, as work request information, a group of captured images of a space in which the client desires to request robot work. The work request information acquisition unit 230 acquires the work request information in association with the robot work service client 102.

The first spatial information generation unit 220 generates first spatial information based on the workability information of the robot work service provider 104 that has been acquired by the workability information acquisition unit 210. The second spatial information generation unit 240 generates second spatial information based on the work request information of the robot work service client 102 that has been acquired by the work request information acquisition unit 230. The degree of coincidence determination unit 250 determines a degree of coincidence based on the first spatial information generated by the first spatial information generation unit 220 and the second spatial information generated by the second spatial information generation unit 240.

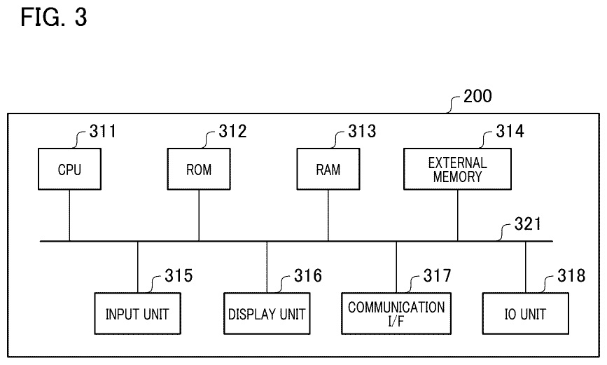

FIG. 3 is a block diagram illustrating a hardware configuration of the information processing apparatus 200. Reference numeral 311 denotes a CPU, which functions as a control unit that controls the operation of each unit of a device connected to a system bus 321 based on a computer program stored in a memory (ROM 312 and the like) serving as a storage medium. Reference numeral 312 denotes the ROM that stores a BIOS program, a boot program, and other computer programs. Reference numeral 313 denotes a RAM, which is used as a main storage device of the CPU 311. Reference numeral 314 denotes external memory, for example, an HDD and an SSD, and stores programs to be processed by the information processing apparatus 200. An input unit 315 performs processing related to the input of information and the like through a keyboard and a mouse. A display unit 316 outputs the calculation results of the information processing apparatus 200 to the display device according to instructions from the CPU 311. Note that the display device may be of any type, such as a liquid crystal display device, a projector, and an LED indicator. This display device may be part of the information processing apparatus 200.

Reference numeral 317 denotes a communication interface that performs information communication via a network, and the communication interface may be Ethernet, and may be of any type such as USB, serial communication, and wireless communication. The communication interface 317 also communicates with an external server and stores various data in the external server. Reference numeral 318 denotes an I/O, which inputs information on robot workability from the robot work service provider 104 or inputs work request information from the robot work service client 102. Additionally, the degree of coincidence determination unit 250 outputs the result of the degree of coincidence to the robot work service client 102, who is the user.

Additionally, some of the functional blocks as shown in FIG. 1 are realized by causing the CPU 311 of the information processing apparatus 200 to execute a computer program stored in a memory (the ROM 312, the external memory 314, and the like) serving as a storage medium. However, some or all of each unit may be realized by hardware. As the hardware, a dedicated circuit (ASIC), a processor (reconfigurable processor, DSP), and the like can be used.

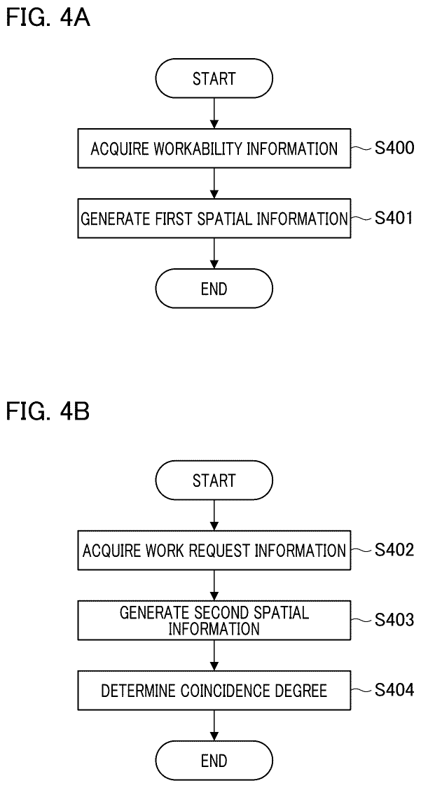

FIG. 4A and FIG. 4B are flowcharts illustrating the operation of the information processing apparatus 200. Hereinafter, it is assumed that the flowchart is realized by the CPU executing a computer program stored in a memory (ROM 312 and the like) serving as a storage medium.

In the first embodiment, the following two processing flows are separately performed. The first is a processing flow for generating the first spatial information based on the workability information acquired from the robot work service provider 104. The second is a processing flow for generating the second spatial information based on the first spatial information and the work request information acquired from the client and determining the degree of coincidence. The processing flow for generating the first spatial information is shown in FIG. 4A. The information processing apparatus 200 starts the operation at an arbitrary timing when the robot work service provider 104 registers the workability information.

In step S400, the workability information acquisition unit 210 acquires workability information from the robot work service provider 104. In the first embodiment, the workability information is input based on the actual work history of the robot work service provider 104. The work history information refers to a group of images captured by a camera mounted on a robot, the position and orientation of the camera at the point where the image was captured, and three-dimensional position information of feature points on the surface of an object in the captured image.

In the first embodiment, the robot autonomously travels via Visual SLAM (Simultaneous Localization and Mapping) wherein the Visual SLAM calculates the position and orientation of the camera based on images captured via the camera mounted on the robot. The information comprising each captured image and the position and orientation of the camera are stored in association with each other. The group of captured images, which serves as the work history information, is defined as images captured at predetermined time intervals or predetermined distance intervals from among the captured images used for the SLAM processing.

In step S401, the first spatial information generation unit 220 generates first spatial information from the information acquired in step S400. In the first embodiment, the first spatial information is an object placement characteristic database.

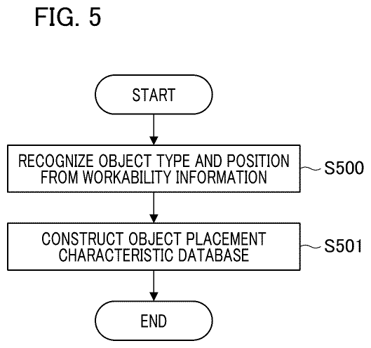

FIG. 5 illustrates a detailed process flow of step S401. In step S500, the type of object included in the captured image group and the position of the object are recognized. Object type recognition is performed by a neural network that has been trained to output the type of object shown in the image and the position of the object on the image when an image is input.

Additionally, a method for recognizing the position of the object type is as follows. First, the three-dimensional position information of the object is obtained based on the position information of the object on the image obtained by the neural network and the three-dimensional position information of the feature point on the captured image obtained through the SLAM processing. Then, the position information of the object in the three-dimensional space is obtained by combining the information on the position and the orientation of the camera at the point at which each captured image has been captured. At this time, all of the position information is unified in the coordinate system of the three-dimensional space defined by the SLAM processing.

Next, an object type vector and a position vector are generated based on the recognized object type and the position of the object. The object type vector is a one-dimensional column vector, and the first element is a CLS token (a special vector representing the start of data). In the vector, the object type labels of the objects that are present in the environment are arranged in the order of the object label corresponding to the first object type information included in the object type information group, the label corresponding to the second object type information, and so on. Additionally, a MASK token (a special label indicating that object type is unknown) is placed as a label corresponding to unidentified objects. In the first embodiment, numerical labels are defined in advance for each object type, and the recognized object type is converted into a numerical label to create an object type vector.

The position vector is a vector in which three elements, which are the three-dimensional positions X, Y, and Z of each object arranged as column vectors, are arranged as a one dimensional column vector. That is, each column of the position vector stores X, Y, and Z values which correspond to the position coordinates of the object in the corresponding column of the object type vector.

Then, in step S501, an object placement characteristic database is constructed by using information on the type of the recognized object and the position of the object. The object placement characteristic database is a database that holds placement characteristics representing the positional relation between a plurality of objects. The placement characteristic is knowledge data indicating the tendency of three-dimensional positional relationships of objects in a space in which work is performed.

The object placement characteristic database in the first embodiment learns, as a neural network, the types and placement relationships of objects in a space in which the robot work service provider 104 can provide work. Specifically, the neural network is a 24-layer stacked neural network based on the Transformer model proposed by Ashish et al. (“Attention is All You Need,” Ashish et al., NeurIPS 2017). In the first embodiment, it is assumed that the number of input dimensions and the number of output dimensions of Transformer are 512 dimensions, that is, a maximum of 512 pieces of object characteristic information are input, and an output of 512 dimensions, which is the same number as the input, is obtained. Specifically, an encoder network used in the method of Jacob et al. is used (Jacob. et. al, BERT: Pre-training of Deep Bidirectional Transformers for Language Understanding, arXiv 2018).

For the object characteristic information, the object type vectors and position vectors generated in step S500 are used.

The processing flow for determining the degree of coincidence is shown in FIG. 4B. In step S402, the work request information acquisition unit 230 acquires work request information related to the space from the robot work client. In the first embodiment, the work request information includes a group of captured images of a space in which the robot work is requested, position and orientation information of the camera during image capturing, and three-dimensional position information of an object surface in the captured image.

In step S403, the second spatial information generation unit 240 generates the second spatial information using the information acquired in step S402 as input. In this step, object type vectors and position vectors in the work request space are generated. The method of generating the object type vectors and the position vectors is similar to that of step S401. That is, the second spatial information generation unit generates the second spatial information related to the space based on the information acquired by the work request information acquisition unit. The second spatial information generation unit generates object type information indicating a type and position information of each of a plurality of objects present in a space in which the robot work service client desires to request work.

In step S404, the degree of coincidence determination unit 250 determines a degree of coincidence based on the first spatial information generated in step S401 and the second spatial information generated in step S403. The object type vectors and position vectors that are second spatial information are input into the object placement characteristic database that is the first spatial information. Then, the output object type vectors and position vectors (third spatial information) are compared with the input object type vectors and position vectors of the second spatial information, and the degree of coincidence is determined from the degree of coincidence of the position vectors for each object type. The third spatial information generation unit generates third spatial information related to the space, which includes the object type information and the position information.

In a method for obtaining the degree of coincidence of the position vectors for each object type, first, the object type group of the second spatial information and the object type group of the third spatial information are sequentially compared, and information on the object type and the position vectors that do not coincide with each other is excluded from the second spatial information and the third spatial information. The distance between the position in the second spatial information and the position in the third spatial information is calculated for each of the remaining object types. If the calculated distance is less than a threshold, 1 is added to the degree of coincidence. This processing is performed for all the remaining object types, and the value of 1 or 0 obtained for each object type is added and averaged to obtain the degree of coincidence. The above is the processing flow that is executed in the information processing apparatus.

According to the first embodiment, it is possible for robot work service clients to select robot work service providers that meet work requirements of the robot work service client.

Note that in the first embodiment, it is assumed that the robot work client is the user. It is possible to determine whether or not to request the robot work service provider 104 based on the degree of coincidence determined by the degree of coincidence determination unit 250. A higher degree of coincidence indicates that a work space in which the robot work service client 102 desires to request work is similar to the space in which the robot work service provider 104 can provide work. Therefore, because the requested space is of low difficulty for the robot work service providers 104, the robot work service client 102 may select a robot work service provider 104 having a high degree of coincidence from among the plurality of robot work service providers 104. That is, the degree of coincidence determination unit 250 determines the degree of coincidence based on the first spatial information related to the specific robot work service client and the second spatial information related to the plurality of robot work service clients.

Note that in the first embodiment, although the object placement characteristic database used for generation of the first or second spatial information is a neural network model using Transformer, the present invention is not limited thereto. The database is not particularly limited as long as the database can recognize the placement characteristics of the objects, and may be a convolutional network, a fully connected network, an RCN, and the like. Additionally, a database holding the object placement characteristic group information may be employed. In a case in which such a database is used, the database can be realized by a configuration in which similar object characteristic group information, object characteristic group information with the highest frequency, or most similar object property group information is output from the registered object characteristic group information. Using such a configuration enables realization with a smaller amount of computation compared to a neural network.

Although it has been explained that the object type vectors and the position vectors are input to the object placement characteristic database, the present invention is not limited thereto. It suffices if object type information and information on the position of each object are represented in a representation that the object placement characteristic database can recognize. For example, the object type information may be an alphabetical label instead of a numerical label, or may be character string data representing the name of the object. As information on the position of each object, the ID of a voxel in which the object is present may be used, instead of the X, Y, and Z coordinate values in the three-dimensional space.

Additionally, although the spatial information of the workspace with a work history acquired from the robot work service provider 104 includes the image group captured by the camera mounted on the robot and the position and orientation of the camera at the point at which the image was captured, the present invention is not limited thereto. A method for acquiring information is not limited if the type of object and the position of the object can be specified. For example, an image captured by a camera not mounted on the robot, for example, a surveillance camera, may be input.

Additionally, the type of the object and the position information of the object may be extracted from the layout diagram of the work site, instead of from the image captured by the camera. In this context, the layout diagram of the object is a plane view of the space in which the types of objects are superimposed in association with the positions corresponding to the positions of the objects that are present in the space. Relative position information of the object can be acquired from the layout diagram. Furthermore, digital data in which the types and positions of objects are recorded may be used instead of the physical layout diagram. In this case, the position of the object may be represented as three-dimensional position information in a space, instead of two-dimensional position information on a plane. According to the drawing information as described above, it is possible to acquire the information on the type and position of the object with higher accuracy.

Additionally, instead of the image captured by the camera, measurement information of another sensor other than the camera, such as LiDAR, which can measure the shape of the space and the distance to the object, may be used together with the object type information. The distance between the measurement point and the object can be measured, and this measurement can be used to calculate the positions of each object for calculating the position vectors. In this case, the object position can be calculated from the sensor measurement value without calculating the object position and the like from the SLAM or the captured image.

Additionally, although the spatial information of the space with a work history acquired from the robot work service provider 104 includes, in addition to a captured image group, both the position and orientation of the camera and the three dimensional position information of feature points on the captured images as results of previously performed SLAM processing, the present invention is not limited thereto. The spatial information of the space with a work history may be only the captured image group, and the first spatial information generation unit 220 may perform the SLAM processing using the captured image group to calculate the position and orientation of the camera and the three-dimensional position information of the feature point corresponding to the object on the captured image.

Similarly to the above, although the work request information acquired from the robot work service client 102 includes, in addition to the captured image group, both the position and orientation of the camera and the three dimensional position information of the feature points on the captured images as results of SLAM processing performed in advance, the present invention is not limited thereto. The work request information may be only the captured image group, and the second spatial information generation unit 240 may perform the SLAM processing using the captured image group to calculate the position and the orientation of the camera and the three-dimensional position information of the feature point corresponding to the object on the captured image.

With respect to the method for calculating the degree of coincidence of position vectors for each object type in the method for determining the degree of coincidence, although the degree of coincidence was calculated based on whether or not the distance between objects of the same type in the search results of the first spatial information and in the second spatial information is equal to or greater than a predetermined threshold value, the present invention is not limited thereto. A plurality of predetermined thresholds may be set, a plurality of numerical values to be set according to the thresholds may be prepared, and the numerical values may be added. The allowable degree for the change amount in each object type varies. By providing the threshold, it is possible to take into consideration the allowable degree for each object type. Alternatively, the amount of change may be added directly and the reciprocal thereof may be used as the degree of coincidence. As a result, it is possible to directly reflect the magnitude of the change amount in the degree of coincidence.

Although it has been explained that the calculation method for the degree of coincidence of position vectors for each object type in the determination method of the degree of coincidence is based on the positions of objects of the same type, the present invention is not limited thereto. The number of objects of the same type in the third spatial information and the second spatial information, which are the search results of the first spatial information, may also be calculated, and it can be considered that the degree of coincidence becomes higher as this number increases. Even when the position measurement accuracy of the object is low, evaluation of the degree of coincidence becomes possible.

Furthermore, the degree of coincidence may be determined based on both information of the positions of objects of the same type and the number of objects of the same type. In this case, it is needless to say that the degree of coincidence becomes higher as the positions of objects of the same type become closer and as the number of objects of identical type becomes larger.

The degree of coincidence may be divided by the number of objects and normalized. Accordingly, the degree of coincidence can be compared even in cases in which the number of objects in the spaces for which work is desired to be requested differs respectively among the plurality of work request information.

Additionally, when presenting the degree of coincidence results to the user, the factor contributing to a high degree of coincidence or the factor contributing to a low degree of coincidence may be output together. The object types with the highest degree of positional coincidence are selected in a predetermined number from the top, and the types of these objects are output as factors contributing to a high degree of coincidence. In contrast, a predetermined number of object types with the lowest degree of positional coincidence are selected from the bottom, and the types of these objects are output as factors contributing to a low degree of coincidence. Additionally, in a case in which there is an object type that is present in only one of the third spatial information or the second spatial information, the object type becomes a factor decreasing the degree of coincidence, and thus the object type is output as a factor contributing to a low degree of coincidence.

The proposed method may be used to determine the degree of coincidence between the requested workspace of the client and the space in which the user can provide work, with the robot work service provider 104 as a user. At this time, a plurality of clients may be set, and the degree of coincidence may be output for each client. The user can determine the level of difficulty of the work requested by the client based on the obtained degree of coincidence. Specifically, as the degree of coincidence becomes higher, the requested workspace of the client and the space with a work history of the user become closer, and thus it can be determined that the difficult level of the work becomes lower. The robot work service client 102 may be set as the user, the degree of coincidence with a plurality of robot work service providers 104 may be determined, and the result may be presented to the user as a ranked list based on the degree of coincidence.

### Second Embodiment

In the first embodiment, the degree of coincidence is determined by comparing the placement relationships of the objects that are present in the space between the spatial information of the space with a work history of the robot work service provider and the spatial information of the space desired to be requested by the robot work service client.

In the second embodiment, a value of parameters (hereinafter, referred to as “spatial information parameters”) related to the difficulty level of the work or the time required for the work is determined based on the placement relationship of the objects. Then, the degree of coincidence is determined based on the degree of proximity of the values of the spatial information parameter group between the work history of the robot work service provider and the request of the robot work service client. Note that only the points differing from the first embodiment will be briefly explained.

In the second embodiment, the configuration diagram and the processing flow are similar to those of the first embodiment. As a method for recognizing the placement location information of each object type, the object placement characteristic database is used as in the first embodiment. In the second embodiment, three types of work, that is, cleaning, delivery, and security, are assumed as the work performed by the robot. The spatial information parameters to be taken into consideration for each type of work of the robot are defined in advance. The spatial information parameters are generated for each robot work type.

First, spatial information parameters common to the work types of cleaning, delivery, and security are defined. Passage width and the size of a level difference are defined as essential conditions for the robot to travel.

Next, spatial information parameters are defined for each work type of the robot. In a case in which the work type of the robot is cleaning, the material to be cleaned is added to the spatial information parameters. The material is required as information for determining a cleaning method including wet wiping and suction. In a case in which the work type of the robot is delivery, the spatial parameters are the number of turns of the robot in the delivery route. In the case of delivery work, it is necessary to determine whether or not a package can be safely carried. Therefore, whether or not the route has few turns is a condition for stable delivery. In a case in which the work type of the robot is security, no spatial information parameters are added.

In step S400, the workability information acquisition unit 210 acquires the workability information in association with the robot service work provider. The workability information in the second embodiment is similar to that in the first embodiment and is as follows. The information includes a captured image group captured by a camera, the position and orientation of the camera at a point where the image was captured, three-dimensional position information of a feature point on the surface of an object on the captured image, and information necessary for calculating each spatial information parameter. Specifically, the additional information necessary for calculating the passage width is the orientation and size of the object in space. The additional information necessary for calculating the material is the material type and the position information of each material. The additional information necessary for calculating the number of turns is information related to the movement route of the robot.

In step S401, the first spatial information is generated from the information acquired by the workability information acquisition unit 210 in association with the robot work service provider. Note that the position information in the second embodiment is unified to the coordinate system defined in the SLAM processing, as in the first embodiment.

In a case in which the spatial information parameter includes the passage width, the object placement characteristic database generated as the first spatial information is as follows. There are four vectors of an object type vector representing an object type, a position vector representing position information of the object, a direction vector representing the direction of the object, and a size vector representing sizes of a length, a width, and a depth of the object. For example, if the object has a shape close to a rectangle, learning is performed so as to output a result close to human perception by setting a direction parallel to the long side as the direction of the object, and recognizing the object. Regarding the length, width, and depth of the object, the dimension in the same direction as the orientation vector is defined as the width, the dimension perpendicular to the orientation vector is defined as the length, and the dimension in the vertical direction is defined as the depth.

In a case in which there is a level difference in the spatial information parameter, the object placement characteristic database is generated by using an object type vector and a position vector as inputs, the position vector wherein the position vector is obtained by measuring the position information of the object at the position on the floor surface. At this time, the position information converted into the position vector is represented by a coordinate system in the SLAM processing.

In a case in which there is a material in the spatial information parameter, the position of the object and the material type of the object are recognized based on the workability information. The position of the object is recognized by performing processing similar to step S401. A recognition method for a material of an object is performed by a neural network wherein the neural network has learned so as to output a type of an object appearing in an image and a material of the object when an image is input. The position vector information for the material type is generated by associating a position vector of an object with a material of each object. A material type vector and a position vector in which the positions of the materials are arranged are added to the object placement characteristic database.

In a case in which the spatial information parameter includes the number of turns, waypoint vectors are added to the input as the route information so as to generate the object placement characteristic database. A waypoint is a via point on a route of the robot. In the second embodiment, a position of a waypoint is represented by X, Y, and Z coordinate values on a coordinate system three-dimensional space defined by the SLAM processing.

In step S402, the work request information acquisition unit 230 acquires, as the work request information, information on the type, the position, the orientation, and the size of the object, which are similar to the workability information in step S400. In a case in which the work type of the robot is delivery, position information of a waypoint is acquired in addition to the type, position, orientation, and size information.

In step S403, a vector serving as second spatial information is generated from the work request information that has been acquired in step S402. The vector to be generated is similar to a vector that is input to the object placement characteristic database in step S401.

In step S404, the degree of coincidence determination unit 250 searches by inputting the object type information and position information included in the second spatial information as keys into the object placement characteristic database, which is the first spatial information, so as to obtain the third spatial information including the object type information and position information. Next, the degree of coincidence is determined by comparing the values of the object type information and the position information obtained from the third spatial information to the values of the object type information and the position information obtained from the second spatial information.

That is, the workability information acquisition unit 210 acquires, in association with the robot work service provider, workability information related to a space in which the robot work service provider can provide work. The first spatial information generation unit 220 generates an object placement characteristic database representing placement relationships of a plurality of objects in a space in which the robot work service provider can provide work, wherein the database serves as first spatial information regarding the space, based on the information acquired by the workability information acquisition unit 210. The work request information acquisition unit 230 acquires the work request information related to a space in which the robot work service client desires to request work wherein the work request information is associated with the robot work service client. Based on the information acquired by the work request information acquisition unit 230, the second spatial information generation unit 240 generates object type information indicating a type and position information of each of a plurality of objects present in a space in which the robot work service client desires to request work wherein the object type information and position information serve as second spatial information. The third spatial information generation unit searches the object placement characteristic database using the object type information and the position information included in the second spatial information as keys and generates third spatial information including the object type information and the position information. The degree of coincidence determination unit 250 determines the degree of coincidence based on the object type information and the position information included in the third spatial information and the object type information and the position information included in the second spatial information.

Next, a calculation method of the spatial information parameter value will be explained. In a case in which the parameter value of the passage width is calculated, the distance to the nearest neighboring object for each object is calculated in the input/output vectors. Because the position, orientation, and size of each object are known, the outer boundary of each object can be determined and by calculating the shortest distance between the outer boundaries of the objects, the distance to the nearest neighboring object is obtained. The distance to the nearest neighboring object is calculated for each object, and a list of calculated distance values is held as parameter values.

In a case in which a level difference is obtained, among coordinate components representing positions of nearest neighboring objects in input/output vectors, a difference in coordinate values of a vertical component with respect to a floor surface is calculated. The difference in height to the nearest neighboring object for each object is calculated, and a list of calculated height difference values is held as parameter values.

In a case in which a number of turns is determined, the nearest neighboring waypoints are connected by a line segment, and in a case in which an angle formed by two line segments at each waypoint is equal to or larger than a predetermined threshold, it is defined that the robot turns, and the number of turns is counted.

In a case in which a material is determined, a list of material types is obtained.

The degree of coincidence is calculated by multiplying the evaluation values obtained for each spatial information parameter by coefficients defined for each spatial information parameter and then calculating a sum for all spatial information parameters in the spatial information parameter group. However, in a case in which any of the evaluation values of the spatial information parameters is a negative value, the degree of coincidence is set to −1.

The evaluation value of the passage width is a value obtained by subtracting the minimum value of the passage width calculated based on the output vector from the minimum value of the passage width calculated based on the input vector. The evaluation value of the level difference is a value obtained by subtracting the maximum value of the level difference calculated based on the input vector from the maximum value of the level difference calculated based on the output vector. The evaluation value of the number of turns is a value obtained by subtracting the number of turns calculated based on the input vector from the number of turns calculated based on the output vector. The evaluation value of the material is 1 in a case in which all of the material types included in the input vector are included in the output vector and is −1 in other cases.

The above is the explanation of the second embodiment. Information on the width of the door may be added to the passage width of the spatial information parameter. In a case in which work is performed in a plurality of rooms, it becomes possible to reflect whether or not a door width permits passage in a degree of coincidence.

Note that although it has been explained that the degree of coincidence is calculated by multiplying the evaluation values obtained for each spatial information parameter by coefficients defined for each spatial information parameter and then summing them across the spatial information parameter group, the present invention is not limited thereto. The evaluation value may be represented by 1 or 0 instead of the value calculated by the method defined by each spatial information parameter. As a result, it becomes possible to calculate the degree of coincidence using only the matched spatial information parameters.

Additionally, the weight may be set in consideration of the degree of importance of the spatial information parameters. Specifically, the passage width and the level difference are weighted with larger values than the other spatial information parameters. As a result, it is possible to obtain the degree of coincidence that reflects whether or not each of the spatial information parameters is an essential condition to be satisfied and whether or not each of the spatial information parameters is a parameter that the user desires to attach importance to.

Additionally, the degree of importance of the spatial information parameter is not limited to whether or not the robot is operable, and may be determined depending on whether or not the spatial information parameter is important to the robot work service provider 104 or the robot work service client 102. Alternatively, whether or not the spatial information parameter is important for a third party affected by the execution of the robot work service may be reflected.

Additionally, although the method using the evaluation value has been explained as the calculation method of the result value, the present invention is not limited thereto. The evaluation value may be calculated by calculating a histogram distribution based on the list of the third spatial information and the list of the second spatial information and comparing the histogram distributions. The degree of overlap of the distribution of the second spatial information with respect to the distribution of the third spatial information is calculated, and the value is set as an evaluation value. Regarding the overlap of the distributions, the area of the overlapped portion is calculated as an evaluation value. At this time, it is determined as to whether the evaluation value is below the maximum threshold or above the minimum threshold according to the spatial information parameters, and in a case in which the determination is negative, the evaluation value is calculated with the area of the portion as a negative value. By comparing the distributions, it becomes possible to compare distribution characteristics with the tendency of the work history of the robot work service provider 104, and it becomes possible to calculate the degree of coincidence in consideration of conditions having more histories.

Note that although it has been explained in the second embodiment that the spatial information parameters are provided for each work type of the robot, the present invention is not limited thereto. Regardless of the type of work performed by the robot, passage width, step differences, the number of turns, and material mentioned for cleaning and delivery may be set and used for determining the degree of coincidence. As a result, it becomes possible to compare spatial information of a space having work history with spatial information of a space in which work is requested, regardless of the work type.

### Third Embodiment

In the second embodiment, a method was explained for determining a degree of coincidence based on a proximity degree between values of a parameter group for object placement and values of a parameter group for a space serving as a service request target, wherein the object placement parameter group relates to a space having work history of a robot work service provider. This time, for the parameters of the service provider, the parameter values are determined based on the object placement characteristic database after the object placement characteristic database is generated.

However, the determination method of the parameter values of the object placement in a space with a work history of the robot work service provider is not limited thereto, and the parameter values may be determined without generating the object placement characteristic database. Specifically, the spatial information parameters are provided for each work type of the robot, and the spatial information parameter values are determined in a manner similar to the generation method of step S403 in the second embodiment. The position and orientation of the camera at the point at which the image was captured and the three-dimensional position information of the feature point corresponding to each object appearing in the captured image are calculated based on the processing results of SLAM processing and used to calculate the spatial information parameter values.

In a case in which parameter values of object placement location are determined without generating the object placement characteristic database, the workability information acquisition unit 210 acquires the workability information related to the space in which the robot work service provider can provide the work wherein the workability information is associated with the robot work service provider. The first spatial information generation unit 220 generates first spatial information related to a space based on the information acquired by the workability information acquisition unit 210. The work request information acquisition unit 230 acquires the work request information related to a space in which the robot work service client desires to request the work in association with the robot work service client. The second spatial information generation unit generates second spatial information related to space based on the information acquired by the work request information acquisition unit 230. The degree of coincidence determination unit 250 determines a degree of coincidence based on the first spatial information and the second spatial information.

In the above explanation, it is assumed that the client of the robot work is the user. It is indicated that as the degree of coincidence is higher, the workspace in which the robot work service client 102 desires to request is more similar to the space in which the robot work service provider 104 can provide the work. Accordingly, it is beneficial for the specific robot work service client 102 to select the robot work service provider 104 with a high degree of coincidence from among the plurality of robot work service providers 104. At this time, the degree of coincidence determination unit 250 determines the degree of coincidence based on the second spatial information related to the specific robot work service client 102 and the first spatial information related to the plurality of robot work service providers 104.

Additionally, the provider of the robot work may serve as a user. In this case, it is beneficial for the specific robot work service provider 104 to select the robot work service client 102 having a high degree of coincidence from among the plurality of robot work service clients 102. At this time, the degree of coincidence determination unit 250 determines the degree of coincidence based on the first spatial information related to the specific robot work service provider 104 and the second spatial information related to the plurality of robot work service clients 102.

Although it has been explained that the result of the SLAM processing is used to calculate the spatial information parameter values, the present invention is not limited thereto. As workability information or work request information, values related to the physical space, such as passage width and door width, may be measured using a measuring device that enables measurement of intervals. The values may also be calculated from an architectural drawing. Parameters related to the movement of the robot, such as the number of turns and waypoints, may be calculated by obtaining robot control information.

Additionally, when the first spatial information is generated, spatial information similar to the space in which the work is requested can be selected from the workability information to calculate the spatial information parameter values. For example, in a case in which the type of space in which the robot work service client desires to request is an office, the first spatial information may be generated by limiting only those with the spatial type “office” from the workability information. As a result, it becomes possible to calculate the degree of coincidence with greater accuracy.

### Fourth Embodiment

In the fourth embodiment, a method of using information other than the spatial information parameters used in the second embodiment and third embodiment to determine the degree of coincidence will be explained. In addition to the spatial information such as the passage width and the material of the floor in the second embodiment and the third embodiment, information related to the level of difficulty of the robot work, such as the weight of the object to be delivered and the lighting environment, is also included. In the fourth embodiment, the information related to the level of difficulty of a robot work is added to the parameters and used to determine the degree of coincidence.

The determination method of the degree of coincidence is similar to the calculation method used in the second embodiment wherein evaluation values obtained for each spatial information parameter are multiplied by coefficients defined for each spatial information parameter and a sum is calculated for all spatial information parameters in a spatial information parameter group.

The above is the explanation of the fourth embodiment. According to the fourth embodiment, it becomes possible to determine the degree of coincidence in consideration of the information related to the level of difficulty of the robot work, in addition to the location information and the spatial information of the object. As a result, the robot work service client 102 may select a provider who can complete the work or can complete the work in a short time. The robot work service provider 104 may also receive a request for completing the work or completing the work in a short time.

### Fifth Embodiment

In the first embodiment, an example has been explained in which, when the result of the degree of coincidence is presented to the robot work service client, the factor contributing to a high degree of coincidence or the factor contributing to a low degree of coincidence is output together. In the fifth embodiment, an example of proposing the combined use of robots having numerical values different from each other for two spatial parameters, such as a robot capable of traveling on a passage having a high level difference and a robot capable of traveling on a passage having a narrow width, is shown.

Among robots of the same work type that may be provided by a robot work service provider, two models having different numerical values for two space parameters are considered. For example, it is assumed that there is a robot A capable of traveling on a passage having a level difference equal to or less than 7 cm and a width equal to or more than 30 cm and a robot B capable of traveling on a passage having a level difference equal to or less than 3 cm and a width equal to or more than 20 cm. Additionally, spatial parameters of second spatial information requested by a client are assumed to have a maximum level difference of 5 cm and a minimum width of 25 cm. In a case in which only one robot is used, robot A alone cannot travel through portions having 25 cm width, and robot B alone cannot travel through portions having 5 cm level differences, resulting in a low degree of coincidence for either height or width when only one robot is used. Therefore, it is possible to propose to the robot work service client the combined use of robots wherein robot A is used in locations with 5 cm level differences and robot B is used in locations with 25 cm width. Note that robot work service providers capable of providing the two robots may be the same or different. Additionally, although the above description is an example of two robots having different numerical values for specific spatial parameters, the number of robots may be three or more.

### Sixth Embodiment

In the sixth embodiment, a case in which a notification unit that provides a notification of the degree of coincidence determined by the degree of coincidence determination unit 250 to the user is provided will be explained.

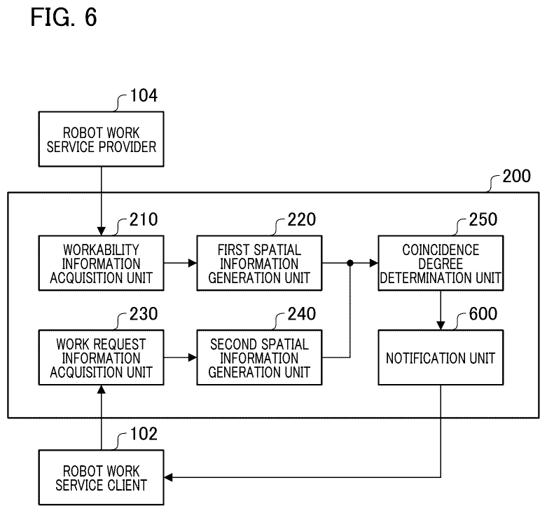

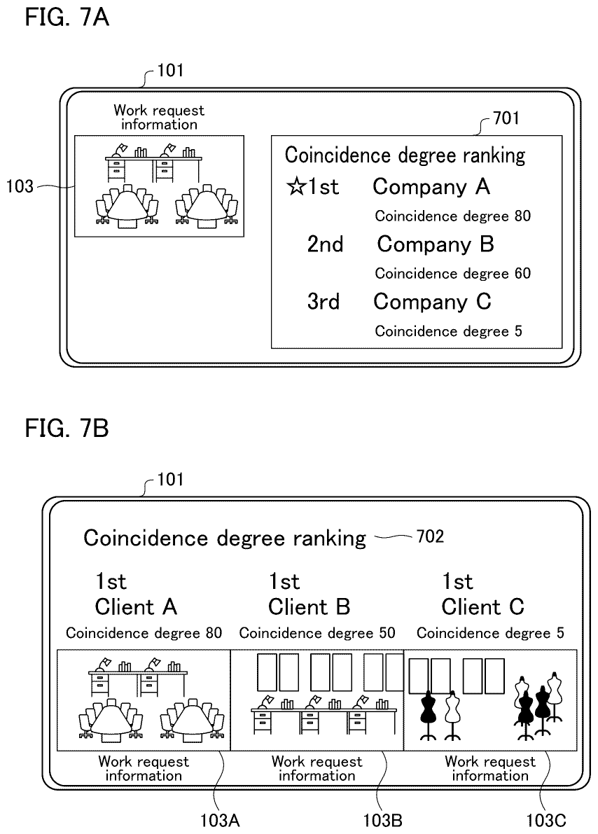

FIG. 6 illustrates a configuration diagram in the sixth embodiment. A notification unit 600 provides a notification of the degree of coincidence determined by the degree of coincidence determination unit 250 to the user. In the sixth embodiment, contents as shown in FIG. 7A are displayed on the display device 101. In a case in which the user is set as the robot work service client 102, a ranking 701 of robot work service providers 104 is displayed, wherein the ranking is determined based on work request information 103 and degree of coincidence results determined by the degree of coincidence determination unit 250. That is, the information in which the robot work service providers and the degree of coincidence are associated with each other is presented to the robot work service client.

By providing the notification unit 600, it is possible to confirm the robot work service provider 104 with a high degree of coincidence.

Note that a selection unit (not illustrated) may be provided wherein a robot work service client 102 serving as a user selects a robot work service provider 104 described in the ranking 701. As a result, the user can promptly select the robot work service provider 104 based on the notification of the degree of coincidence and complete an entire process up to requesting the robot work service.

In a case in which the user is set as the robot work service provider 104, a display example is as shown in FIG. 7B. By displaying the degree of coincidence together with the work request information from each client, the robot work service provider 104 may determine which request would have a lower work difficulty. Additionally, a ranking 702 of degrees of coincidence with the robot work service client 102 is also notified. That is, the information in which the robot work service client and the degree of coincidence are associated with each other is presented to the robot work service provider.

Note that a selection unit (not illustrated) may be provided wherein a robot work service provider 104 serving as a user selects a robot work service client 102 listed in the ranking 702. As a result, the user may promptly select the robot work service client 102 based on the notification of the degree of coincidence and complete an entire process up to receiving a request for the robot work service.

Note that the display contents are not limited to the contents shown in FIG. 7A and FIG. 7B. The degree of coincidence may be displayed by a numerical bar or a graph instead of a numerical value. Alternatively, the degree of coincidence may be displayed at levels such as high, medium, and low. Information obtained from sources other than the result of the degree of coincidence, such as estimated costs or available reservation dates, is not limited. The notification method of notification unit 600 is not limited to display, and the notification may be performed by voice.

### First Variant Embodiment

In the first variant embodiment, a case is explained in which a storage unit is provided to store the first spatial information generated from the workability information obtained from the robot work service provider 104. Note that only the differences from the other embodiments will be briefly explained.

A spatial information storage unit (not illustrated) stores the first spatial information generated by the first spatial information generation unit 220.

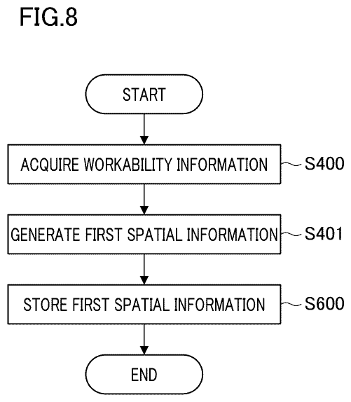

A storage process flow of the first spatial information in the first variant embodiment is illustrated in FIG. 8. In step S600, the first spatial information storage unit stores the first spatial information generated in step S401. In this case, the storage destination is a memory (the ROM 312, the external memory 314, and the like) serving as a storage medium.

According to the first variant embodiment, workability information obtained from the robot work service provider 104 may be stored, and the degree of coincidence may be determined by using more information. Because a large amount of information can be used for learning of the object placement characteristic database, improvement in accuracy can be expected.

Note that as a storage method of the first spatial information, although it has been explained that all the work histories are stored as one piece of data, the method is not limited thereto. For example, spatial information may be divided and stored for each work type of a robot. Alternatively, spatial information may be divided and stored for each parameter.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-028162, filed Feb. 28, 2024, which is hereby incorporated by reference wherein in its entirety.

What is claimed is:

1. An information processing apparatus comprising:
at least one processor and a memory holding a program that makes the processor function as:
a workability information acquisition unit configured to acquire, in association with a robot work service provider, workability information related to a space in which the robot work service provider can provide work;
a first spatial information generation unit configured to generate first spatial information related to a space based on the workability information acquired by the workability information acquisition unit;
a work request information acquisition unit configured to acquire, in association with a robot work service client, work request information related to a space in which the robot work service client desires work to be provided;
a second spatial information generation unit configured to generate second spatial information related to a space based on the work request information acquired by the work request information acquisition unit; and
a degree of coincidence determination unit configured to determine a degree of coincidence based on the first spatial information and the second spatial information.

2. The information processing apparatus according to claim 1, wherein, based on the degree of coincidence determined by the degree of coincidence determination unit, information associating the robot work service provider and the degree of coincidence is presented to the robot work service client.

3. The information processing apparatus according to claim 1, wherein, based on the degree of coincidence determined by the degree of coincidence determination unit, information associating the robot work service client and the degree of coincidence is presented to the robot work service provider.

4. The information processing apparatus according to claim 1,
wherein the first spatial information and the second spatial information include spatial information parameters related to a difficulty level of robot work, and
wherein the degree of coincidence determination unit determines the degree of coincidence based on a value of the spatial information parameters.

5. The information processing apparatus according to claim 4, wherein the spatial information parameter is defined in advance for each work type of robot work, and a value of the spatial information parameter is determined for each work type of the robot work.

6. An information processing apparatus comprising:
at least one processor and a memory holding a program that makes the processor function as:
a workability information acquisition unit configured to acquire, in association with a robot work service provider, workability information related to a space in which the robot work service provider can provide work;
a first spatial information generation unit configured to generate, based on the workability information acquired by the workability information acquisition unit, first spatial information related to a space that is an object placement characteristic database representing positional relationships of a plurality of objects in a space in which the robot work service provider can provide work;
a work request information acquisition unit configured to acquire, in association with a robot work service client, work request information related to a space in which the robot work service client desires work to be provided;
a second spatial information generation unit configured to generate, based on the work request information acquired by the work request information acquisition unit, second spatial information related to space comprising object type information and position information indicating a type of each of a plurality of objects present in a space in which the robot work service client desires work to be provided;
a third spatial information generation unit configured to search the object placement characteristic database using the object type information and the position information included in the second spatial information as a key, and generate third spatial information related to a space comprising the object type information and the position information; and
a degree of coincidence determination unit configured to determine a degree of coincidence based on the object type information and the position information included in the third spatial information and the object type information and the position information included in the second spatial information.

7. The information processing apparatus according to claim 6,
wherein the object placement characteristic database includes spatial information parameters related to a difficulty level of robot work, and
wherein the degree of coincidence determination unit determines the degree of coincidence based on a value of the spatial information parameters.

8. The information processing apparatus according to claim 7, wherein the spatial information parameters are defined in advance for each work type of robot work, and the value of the spatial information parameters is generated for each work type of the robot work.

9. An information processing method comprising:
acquiring, in association with a robot work service provider, workability information related to a space in which the robot work service provider can provide work;
generating first spatial information related to a space based on the workability information;
acquiring, in association with a robot work service client, work request information related to a space in which the robot work service client desires work to be provided;
generating second spatial information related to a space based on the work request information; and
determining a degree of coincidence based on the first spatial information and the second spatial information.
